(19) United States
(12) Patent Application Publication
(10) Pub. No.: US 2011/0238731 A1
(43) Pub. Date: Sep. 29, 2011

(54) METHOD TO PROVIDE AN UNLIMITED NUMBER OF CUSTOMIZED USER INTERFACES

(75) Inventor: Gregory A. Corson, San Mateo, CA (US)

(73) Assignee: SONY CORPORATION, Tokyo (JP)

(21) Appl. No.: 12/729,341

(22) Filed: Mar. 23, 2010

(51) Int. Cl. G06F 3/01; G06F 15/16

(52) U.S. Cl. 709/203; 715/745

(57) ABSTRACT

A method of providing an unlimited number of customized user interfaces ensure that the user interface on a controlling device is appropriately configured for the controlling device as well as ensuring the controlling device is appropriately configured to control a controlled device. Each of the devices publishes a description of messages that are utilized with the device. A script is then developed based on the description of the messages to enable proper communication between the devices. The script is downloaded to the controlling device so that the controlling device is able to utilize the script for communicating with the controlled device. With the script, the controlling device will have an appropriately configured user interface and control the controlled device properly.

### FIELD OF THE INVENTION

The present invention relates to the field of user interfaces. More specifically, the present invention relates to customized user interfaces using a Remote User Interface.

### BACKGROUND OF THE INVENTION

The number of electronic devices in people's homes is continually increasing. Many years ago, homes only had a radio; then, a radio and a television. The number of devices has increased to the point where a typical home has several televisions, stereos, computers, video game consoles, mobile phones/devices, appliances and others. Furthermore, these devices are gaining intelligence so that they are able to communicate with each other.

A standard, referred to as Remote User Interface (RUI or Remote UI) is being developed to allow devices to operate each other and provide the user with a user interface that is configured appropriately for a device being used to control another device. For example, a user interface for a television which is 46″ wide is not likely to appear properly on a mobile phone which has a display of 2″. The Remote UI standard is a web-based protocol and framework for remote user interface on UPnP (Universal Plug and Play) Networks and the Internet. The standard allows a UPnP-capable home network device to provide its interface (display and control options) as a web page to display on any other device coupled to the home network.

A Remote UI client is able to be a fully autonomous device that runs its own interface in addition to executing remoted UIs, or it may be a fully remoted device with no local UI capability.

Controlling devices vary widely in size and capabilities. One user interface design will not work for all controlling devices. In the past, controlled devices have tried to export several user interface designs such as a website that exports “full,” “mobile” and “text” versions. The controlling device selects one and attempts to “make it fit” generating user interfaces that are poorly designed for the controlling device, hard for users to use/understand and that do not take advantage of the controlling device's capabilities. Supporting multiple user interfaces from the controlled device also puts an unreasonable load on the device and requires software updates to add new customizations. User generated customizations are usually not possible as many consumer devices cannot be updated by the user.

### SUMMARY OF THE INVENTION

A method of providing an unlimited number of customized user interfaces ensure that the user interface on a controlling device is appropriately configured for the controlling device as well as ensuring the controlling device is appropriately configured to control a controlled device. Each of the devices publishes a description of messages that are utilized with the device. A script is then developed based on the description of the messages to enable proper communication between the devices. The script is downloaded to the controlling device so that the controlling device is able to utilize the script for communicating with the controlled device. With the script, the controlling device will have an appropriately configured user interface and control the controlled device properly.

In one aspect, a method of providing a customized user interface comprises publishing information about a first device and a second device, utilizing the information about the first device and the second device to develop a script and storing the script on a server to be distributed. The script is developed automatically without user intervention. The customized user interface includes a customized screen size and display settings based on the first device and the second device. The first device is a controlling device and the second device is a controlled device. The information includes a description of messages the controlling device scans for. The information about the controlling device is published independently of the information about the controlled device. The script is specifically designed for a combination of the controlling device and the controlled device. The controlling device and the controlled device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

In another aspect, a method of utilizing a customized user interface comprises discovering a controlled device with a controlling device, publishing device information from the controlled device, sending the device information about the controlling device and the controlled device to a server to locate a script, acquiring the script from the server on the controlling device and controlling the controlled device with the controlling device utilizing the script. Discovering further comprises contacting the controlled device with the controlling device to determine the device information of the controlled device. Device information includes at least one of a device name, a device brand and an identification number. The script provides the customized user interface specifically for the controlling device. The script provides the customized user interface specifically for the controlling device and the controlled device. The script is located by searching for names of the controlling device and the controlled device. The script is based on a configuration with the controlling device and the controlled device. The script provides responses to messages that the controlling device and the controlled device scan for. The controlling device and the controlled device are synchronized. The controlling device and the controlled device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

In yet another aspect, a system for utilizing a customized user interface comprises a discovering module for discovering a controlled device with a controlling device, a sending module for sending information about the controlling device and the controlled device to search for a script, an acquisition module for acquiring the script from a server and a controlling module for controlling the controlled device by sending and receiving messages. The discovering module contacts the controlled device to determine device information about the controlled device. The device information includes at least one of a device name, a device brand and an identification number. Search is based on the names of the controlling device and the controlled device. The controlling device and the controlled device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

In yet another aspect, a network of devices comprises a server for storing a script and distributing the script over a network, a controlled device for being controlled remotely and a controlling device for searching for and acquiring the script to control the controlled device.

In another aspect, a controlling device comprises a memory for storing an application, the application for discovering a controlled device, sending device information about the controlling device and the controlled device to a server to locate a script, acquiring the script from the server and controlling the controlled device utilizing the script and a processing component coupled to the memory, the processing component configured for processing the application.

### BRIEF DESCRIPTION OF THE DRAWINGS

FIG. 1 illustrates a network of devices utilizing customized interfaces according to some embodiments.

FIG. 2 illustrates a block diagram of a controlling device and a controlled device according to some embodiments.

FIG. 3 illustrates a flowchart of a method of providing a remote user interface for devices according to some embodiments.

FIG. 4 illustrates a flowchart of a method of utilizing a remote user interface to control a device according to some embodiments.

FIG. 5 illustrates a block diagram of an exemplary computing device configured to implement any aspect of the method of providing an unlimited number of customized user interfaces according to some embodiments.

### DETAILED DESCRIPTION OF THE PREFERRED EMBODIMENT

A system for and method to provide an unlimited number of customized remote user interfaces for a device without putting the load of all of these user interfaces on the device by separating the description of the user interface from the information about what is able to be controlled on the device or the state of the device is described herein. The method is able to generate any number of user interface designs, customized for a grouping (e.g. pairs) of controlling and controlled devices. Updates to either device are not required when a new user interface is added. Generators of new controlling devices are able to generate user interface designs that work well with the screen size and capabilities of their device. When no user interface design exists for a particular set of controlling and controlled devices, a generic user interface that closely fits both devices is able to be used or generated automatically to allow some level of control. The end results are clear and usable interfaces that are able to be customized by user or manufacturers at any time.

The customized user interfaces are able to utilize the Remote User Interface (UI) standard which is an aspect of the Universal Plug and Play (UPnP) standard. By implementing customized user interfaces on each device, a user is able to have a smoother experience using the devices, while taking advantage of using a variety of devices for controlling other devices. The customized user interface on a controlling device is appropriately sized and configured for the controlling device. Additionally, the control by the controlling device of a controlled device is accurate. For example, by having a customized X-type mobile phone user interface to communicate with a Y-type television, the user will be able to utilize the mobile phone efficiently and easily, as opposed to a one-size-fits-all user interface which usually does not fit any device well.

To provide customized user interfaces, low level information (e.g. control information) is exchanged between the devices. For example, a controlling device is able to determine the state of a controlled device and is able to change the state of the controlled device using the information exchanged. The controlled device publishes information such as a description of messages that it listens to and the information that it retrieves. The description of messages is sent to a server. Then, the description of messages is interpreted, and a script is developed so that another device is able to control the device to be controlled.

For example, to control a television on/off button, the television monitors for a message to determine if the television is on or off and the message to turn the television on or off. An entity is able to build a script that says if one is trying to control a Y-type television with an X-type phone, use this script. Continuing with the example, the script then places a little green power button on the phone screen. When the button appears, the phone sends a message to the television, “tell me whether you are on or off.” The result of the response determines if the green button is illuminated or remains dark. When a user pushes the button, the television receives a message to either turn on or turn off the television. An interpreter stored on the phone is able to determine the input and output of a script. Many scripts are able to be available for the phone so that there is a script for each possible configuration (e.g. X-type phone with Y-type television).

To initialize the communication between the devices, the phone first acquires the script by contacting the server to obtain (e.g. download) the script for this configuration. The phone is able to query the television to determine its type and then present the configuration to the server to retrieve the appropriate script. The controlling devices and the controlled devices are able to publish information regarding themselves such as messages they look out for, a list of actions that they are able to perform and/or information they are able to present. Scripts are able to be developed for the combinations of devices using this information, so that the devices are able to communicate with each other.

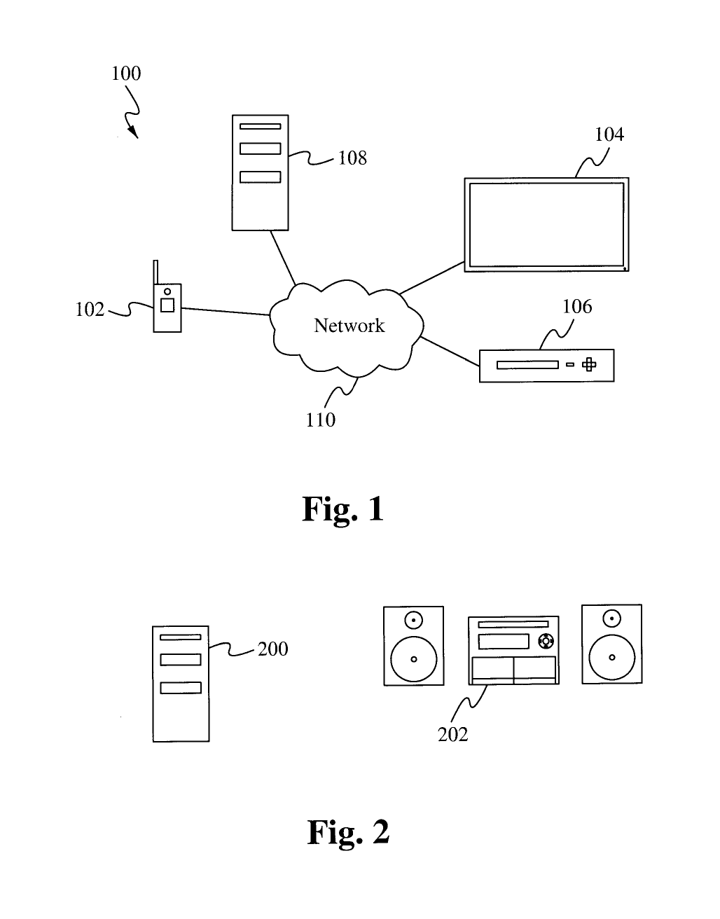

FIG. 1 illustrates a network of devices 100 utilizing customized interfaces according to some embodiments. A controlling device 102, a first controlled device 104, a second controlled device 106 and a server 108 are operatively coupled through a network 110. The devices are also able to be directly coupled, for example, the controlling device 102 is able to be directly coupled to the first controlled device 104 and the second controlled device 106.

The controlling device 102 (e.g. mobile phone) communicates with the first controlled device 104 (e.g. television) to determine the type of device the first controlled device 104 is. The first controlled device 102 retrieves a script stored on the server 108 that has been specifically developed for the combination of the controlling device 102 and the first controlled device 104. The script ensures the user interface on the controlling device 102 is the appropriate size and configuration. The script also ensures the controlling device 102 sends the appropriate requests and commands to the first controlled device 104. The controlling device 102 is able to control the first controlled device 104 using any functionality that the first controlled device 104 is able to accept. For example, the mobile phone is able to be used as a remote control for the television with the functionality of turning the television on/off, changing channels, changing volume, changing television settings and any other functions that the television has.

The controlling device 102 also communicates with the second controlled device 106 (e.g. a Blu-ray® player). Again, the controlling device 102 determines the type of device the second controlled device 106 is. The first controlled device 102 retrieves a script stored on the server 108 that has been specifically written for the combination of the controlling device 102 and the second controlled device 106. The script ensures the user interface on the controlling device 102 is the appropriate size and configuration. The script also ensures the controlling device 102 sends the appropriate requests and commands to the second controlled device 106. The controlling device 102 is able to control the second controlled device 106 using any functionality that the second controlled device 106 is able to accept. For example, the mobile phone is able to be used as a remote control for the Blu-ray® player with the functionality of turning the player on/off, play/stop/pause, selecting menu options, changing chapters, fast forward/rewind, eject, changing player settings and any other functions that the player has.

The server 108 is able to be any computing device capable of storing and serving data such as a standard server. The information stored on the server 108 includes scripts and any other information useful in developing the scripts. For example, lists or descriptions of messages sent/received by a device are able to be stored on the server 108. Furthermore, the server 108 is able to be one or more servers which are able to act jointly or independently of each other.

The network 110 is able to be any type of network such as a Local Area Network (LAN), a Wide Area Network (WAN), the Internet, a network of networks or any other network. Additionally, the type of network is able to be wireless, wired, cellular, any other type of network or any combination of two or more networks. In some embodiments, a network is not used and devices are directly coupled. Although the network of devices shown includes a controlling device and two controlled devices, any number of controlling and/or controlled devices is possible, for example one controlling device and one controlled device.

FIG. 2 illustrates a block diagram of a controlling device 200 and a controlled device 202 according to some embodiments. The controlling device (e.g. PDA) 200 communicates with the controlled device (e.g. stereo) 202 to obtain the controlled device's information. The controlling device 200 then obtains a script for the combination of the specific PDA and the specific stereo. The controlling device 200 then utilizes the script to display the device-specific user interface and provide the correct device-specific commands to the controlled device 202.

In some embodiments, the controlling device includes stored scripts. For example, scripts for the most popular devices at the time are included. In some embodiments, the scripts are able to be downloaded in advance. For example, the user is able to specify that he has device A and is planning on purchasing device B and will be using them with each other.

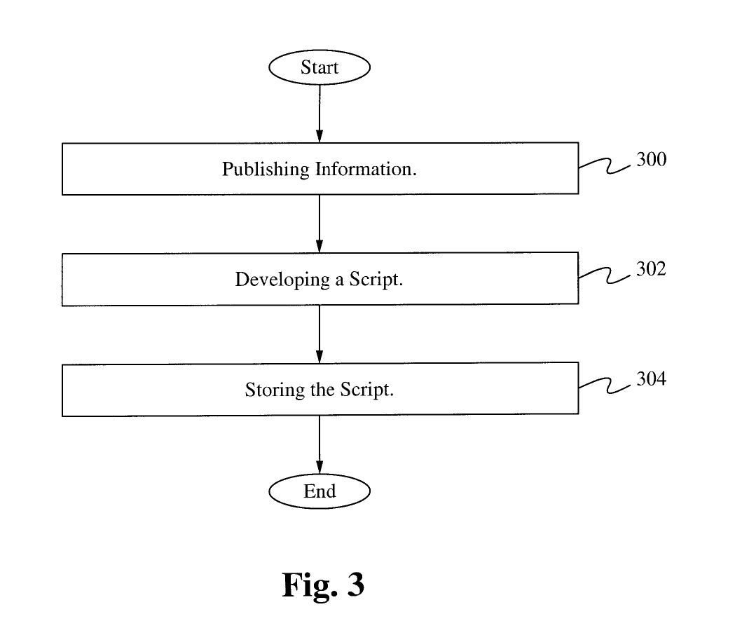

FIG. 3 illustrates a flowchart of a method of providing a remote user interface for devices according to some embodiments. Although not a step, the devices utilizing the remote user interface include a framework according to the Remote UI standard of UPnP. For example, devices provide certain information when queried. In the step 300, a device publishes the type of information/queries it monitors for and what input it receives. For example, a device to be controlled publishes a description of messages that it scans for, and a device to control publishes a description of messages that it scans for. In the step 302, someone, such as a developer, utilizes information (e.g. the description of messages) about a controlling and a controlled device to develop a script. In some embodiments, instead of a person developing a script, a script is automatically generated without user intervention. If standard functions are utilized, for example <power> to control power on/off, a script is able to be automatically generated based on information received regarding a controlled device and/or a controlling device. In the step 304, the script is stored to be distributed to controlling devices. The script is able to be stored anywhere such as on a server, a controlled device and/or a controlling device. Although specific steps are described, in some embodiments, fewer or more steps are included, and/or the order of the steps is able to be changed.

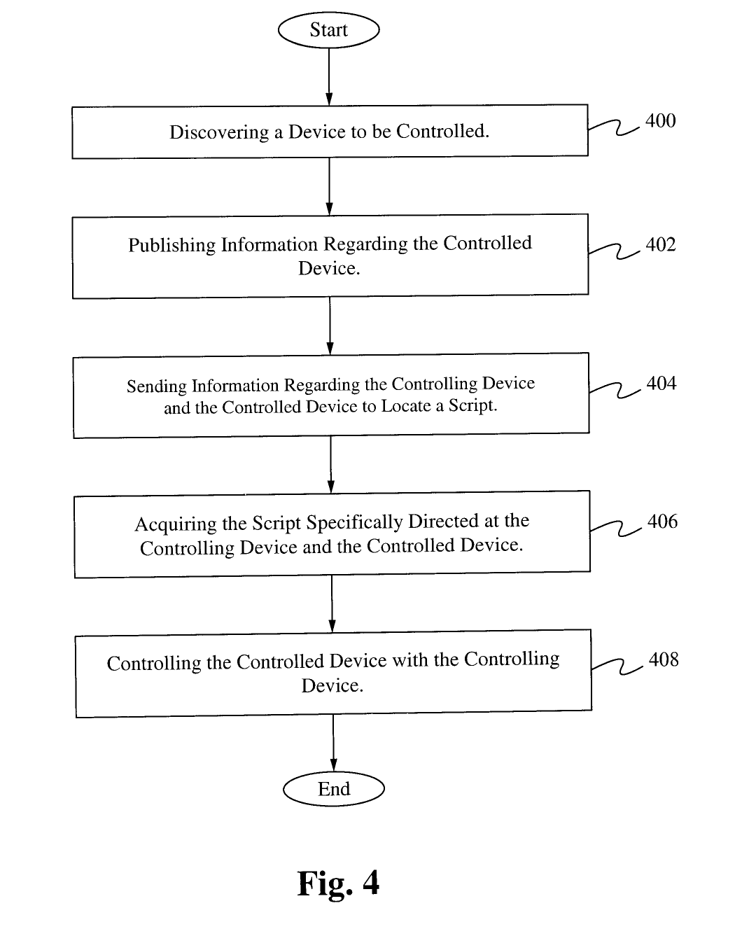

FIG. 4 illustrates a flowchart of a method of utilizing a remote user interface to control a device according to some embodiments. In the step 400, a controlling device discovers a device to control (e.g. the controlling device contacts the device to be controlled to determine the type of device). In the step 402, the device to be controlled, also referred to as the controlled device, publishes information about itself (e.g. power on, channel number, name of device, model number and any other information). Some of the published information is read only such as model number and some of the published information is read/write such as power on/off or channel number. In the step 404, the controlling device sends information regarding the controlling device and the controlled device to a server to retrieve a script based on the two devices. The controlling device searches for the script in any manner. For example, the controlling device searches for two product names such as (iPhone+SonyXBR8). If this does not return a match, the search is able to be based on one of the devices, or a search is able to be based on devices that are reasonably similar (for example, a 46″ television from Panasonic® is reasonably similar to a 46″ television from Sony®). In the step 406, the controlling device downloads the script which is configured to operate with the underlying framework stored on the controlling device. The script couples the controlling device input and output with the published information of the controlled device. Once the script is downloaded, then in the step 408, the controlling device controls the controlled device using the script by sending and retrieving the appropriate information. Any state changes on the controlling device are sent to the controlled device causing the controlled device's state to change. Further, any state changes on the controlled device are published to the script causing its state to change on the controlling device. Since the state changes are immediately sent between the controlling device and the controlled device, they are always be in sync. Although specific steps are described, in some embodiments, fewer or more steps are included, and/or the order of the steps is able to be changed.

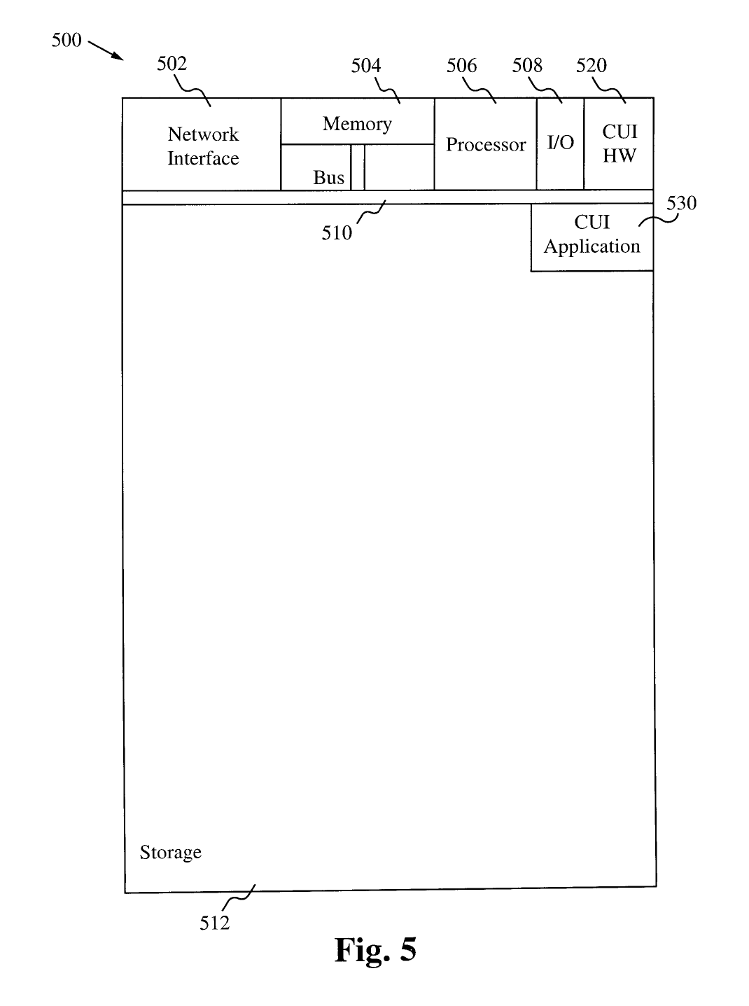

FIG. 5 illustrates a block diagram of an exemplary computing device 500 configured to implement any aspect of the method of providing an unlimited number of customized user interfaces according to some embodiments. The computing device 500 is able to be used to acquire, store, compute, communicate and/or display information. For example, the computing device 500 is able to acquire, store and execute a script. In another example, the computing device 500 is able to be used to develop a script. In yet another example, the computing device 500 is able to store and distribute scripts. Although these examples have been listed, the computing device 500 is able to be configured to implement the any aspect of the methods described herein. Depending on the aspect of the customized user interface method being used, the method is able to be used upon startup of controlling a device with another device, while controlling the device with another device, or any other time. In general, a hardware structure suitable for implementing the computing device 500 includes a network interface 502, a memory 504, a processor 506, I/O device(s) 508, a bus 510 and a storage device 512. The choice of processor is not critical as long as a suitable processor with sufficient speed is chosen. The memory 504 is able to be any conventional computer memory known in the art. The storage device 512 is able to include a hard drive, CDROM, CDRW, DVD, DVDRW, Blu-ray®, flash memory card or any other storage device. The computing device 500 is able to include one or more network interfaces 502. An example of a network interface includes a network card connected to an Ethernet or other type of LAN. The I/O device(s) 508 are able to include one or more of the following: keyboard, mouse, monitor, display, printer, modem, touchscreen, button interface and other devices. Customized user interface application(s) 530 used to perform the customized user interface method are likely to be stored in the storage device 512 and memory 504 and processed as applications are typically processed. More or less components shown in FIG. 5 are able to be included in the computing device 500. In some embodiments, improved customized user interface 520 is included. Although the computing device 500 in FIG. 5 includes applications 530 and hardware 520, the customized user interface method is able to be implemented on a computing device in hardware, firmware, software or any combination thereof. For example, in some embodiments, the customized user interface applications 530 are programmed in a memory and executed using a processor. In another example, in some embodiments, the customized user interface hardware 520 is programmed hardware logic including gates specifically designed to implement the customized user interface method.

In some embodiments, the customized user interface application(s) 530 include several applications and/or modules. As described herein, a publishing module publishes information about device(s). The information is published to a server or another device that is able to utilize the information. A messaging module receives and/or transmits information (e.g. messages). A discovering module discovers a device to control, for example, contacting the other device to determine device information about that device such as device type, device brand, device name, an identification number and/or any other information. A sending module sends information regarding the controlling device and the controlled device to search for a script. The searching is able to be by any method, for example, based on the names of the controlling device and the controlled device. An acquisition module acquires a script from a server or other location. The acquisition module is able to be utilized manually or automatically without user intervention depending on the implementation. In some embodiments, the acquisition module ensures that the script acquired is a correct combination of the controlling device and the controlled device. A controlling module controls a controlled device by sending and receiving the proper information to and from the controlling device and the controlled device. A developing module is able to develop scripts automatically. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone, a video player, a DVD writer/player, a Blu-ray® writer/player, a television, a home entertainment system or any other suitable computing device. In some embodiments, a computing device is able to include intelligent appliances such as a refrigerator, a toaster, a toaster oven and a microwave, where the appliances are able to process and/or present information.

The controlling device, the controlled device and the server are all able to be any of these computing devices and any other devices that would benefit from the description herein.

Although a script has been described as including a pair of devices herein, in some embodiments, more than two devices are able to be grouped together in a script.

To utilize the customized user interfaces, a developer receives information regarding the devices and develops a script for the configuration with the devices. The generated script is then able to be used to present a customized user interface on a device and to control another device. To utilize the customized user interfaces on devices, a customized user interface is downloaded to a controlling device. The user interface displays correctly for the device since it has been customized for that device. Further, the controlling device is able to control a controlled device accurately because the script has been customized for the controlled device as well.

In operation, the customized remote user interface is able to provide an appropriately sized and configured user interface on a controlling device as well as provide accurate input/output to/from the controlled device. This is performed without custom software being developed for each controlling device and controlled device or a remote web page interface. Further, the software on the controlling device and the controlled device does not need to be changed. Instead, the devices transmit information based on a standard, and then independent of the programming on the devices, an interface is able to be designed so that they are able to communicate. For example, a television is able to be programmed to output certain information regardless of what device is controlling the television. This enables a small amount of information to be programmed into the television, and the software and/or hardware controlling the television to present this information does not need to be changed based on the controlling device.

Example: remote control power button

A user interface design script to display a power on/off switch on a phone for a television is able to appear as follows:

1. Generate a power switch widget at location x, y size h, w on the screen. This draws the power switch on the screen of the phone.

2. Couple the power button state to <power> on the television. This couples the state of the power switch on the phone's screen to match what the television is publishing so that the widget will light up if the television is on and will go dark when the television is off.

3. Couple the output of the power switch widget to <power> on the television. When the user touches the power switch widget on the phone, the phone's state will change between off and on. The new state will be sent to the television, turning it off or on to match the state of the widget.

### Some Embodiments of a Method to Provide an Unlimited Number of Customized User Interfaces

1. A method of providing a customized user interface comprising:
   a. publishing information about a first device and a second device;
   b. utilizing the information about the first device and the second device to develop a script; and
   c. storing the script on a server to be distributed.
2. The method of clause 1 wherein the script is developed automatically without user intervention.
3. The method of clause 1 wherein the customized user interface includes a customized screen size and display settings based on the first device and the second device.
4. The method of clause 1 wherein the first device is a controlling device and the second device is a controlled device.
5. The method of clause 4 wherein the information includes a description of messages the controlling device scans for.
6. The method of clause 4 wherein the information about the controlling device is published independently of the information about the controlled device.
7. The method of clause 4 wherein the script is specifically designed for a combination of the controlling device and the controlled device.
8. The method of clause 4 wherein the controlling device and the controlled device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.
9. A method of utilizing a customized user interface comprising:
   a. discovering a controlled device with a controlling device;
   b. publishing device information from the controlled device;
   c. sending the device information about the controlling device and the controlled device to a server to locate a script;
   d. acquiring the script from the server on the controlling device; and
   e. controlling the controlled device with the controlling device utilizing the script.
10. The method of clause 9 wherein discovering further comprises contacting the controlled device with the controlling device to determine the device information of the controlled device.
11. The method of clause 9 wherein the device information includes at least one of a device name, a device brand and an identification number.
12. The method of clause 9 wherein the script provides the customized user interface specifically for the controlling device.
13. The method of clause 9 wherein the script provides the customized user interface specifically for the controlling device and the controlled device.
14. The method of clause 9 wherein the script is located by searching for names of the controlling device and the controlled device.
15. The method of clause 9 wherein the script is based on a configuration with the controlling device and the controlled device.
16. The method of clause 9 wherein the script provides responses to messages that the controlling device and the controlled device scan for.
17. The method of clause 9 wherein the controlling device and the controlled device are synchronized.
18. The method of clause 9 wherein the controlling device and the controlled device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.
19. A system for utilizing a customized user interface comprising:
   a. a discovering module for discovering a controlled device with a controlling device;
   b. a sending module for sending information about the controlling device and the controlled device to search for a script;
   c. an acquisition module for acquiring the script from a server; and
   d. a controlling module for controlling the controlled device by sending and receiving messages.
20. The system of clause 19 wherein the discovering module contacts the controlled device to determine device information about the controlled device.
21. The system of clause 20 wherein the device information includes at least one of a device name, a device brand and an identification number.
22. The system of clause 19 wherein search is based on the names of the controlling device and the controlled device.
23. The system of clause 19 wherein the controlling device and the controlled device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.
24. A network of devices comprising:
   a. a server for storing a script and distributing the script over a network;
   b. a controlled device for being controlled remotely; and
   c. a controlling device for searching for and acquiring the script to control the controlled device.
25. A controlling device comprising:
   a. a memory for storing an application, the application for:
      i. discovering a controlled device;
      ii. sending device information about the controlling device and the controlled device to a server to locate a script;
      iii. acquiring the script from the server; and
      iv. controlling the controlled device utilizing the script; and
b. a processing component coupled to the memory, the processing component configured for processing the application.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of providing a customized user interface comprising:
a. publishing information about a first device and a second device;
b. utilizing the information about the first device and the second device to develop a script; and
c. storing the script on a server to be distributed.

2. The method of claim 1 wherein the script is developed automatically without user intervention.

3. The method of claim 1 wherein the customized user interface includes a customized screen size and display settings based on the first device and the second device.

4. The method of claim 1 wherein the first device is a controlling device and the second device is a controlled device.

5. The method of claim 4 wherein the information includes a description of messages the controlling device scans for.

6. The method of claim 4 wherein the information about the controlling device is published independently of the information about the controlled device.

7. The method of claim 4 wherein the script is specifically designed for a combination of the controlling device and the controlled device.

8. The method of claim 4 wherein the controlling device and the controlled device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

9. A method of utilizing a customized user interface comprising:
a. discovering a controlled device with a controlling device;
b. publishing device information from the controlled device;
c. sending the device information about the controlling device and the controlled device to a server to locate a script;
d. acquiring the script from the server on the controlling device; and
e. controlling the controlled device with the controlling device utilizing the script.

10. The method of claim 9 wherein discovering further comprises contacting the controlled device with the controlling device to determine the device information of the controlled device.

11. The method of claim 9 wherein the device information includes at least one of a device name, a device brand and an identification number.

12. The method of claim 9 wherein the script provides the customized user interface specifically for the controlling device.

13. The method of claim 9 wherein the script provides the customized user interface specifically for the controlling device and the controlled device.

14. The method of claim 9 wherein the script is located by searching for names of the controlling device and the controlled device.

15. The method of claim 9 wherein the script is based on a configuration with the controlling device and the controlled device.

16. The method of claim 9 wherein the script provides responses to messages that the controlling device and the controlled device scan for.

17. The method of claim 9 wherein the controlling device and the controlled device are synchronized.

18. The method of claim 9 wherein the controlling device and the controlled device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

19. A system for utilizing a customized user interface comprising:
a. a discovering module for discovering a controlled device with a controlling device;
b. a sending module for sending information about the controlling device and the controlled device to search for a script;
c. an acquisition module for acquiring the script from a server; and
d. a controlling module for controlling the controlled device by sending and receiving messages.

20. The system of claim 19 wherein the discovering module contacts the controlled device to determine device information about the controlled device.

21. The system of claim 20 wherein the device information includes at least one of a device name, a device brand and an identification number.

22. The system of claim 19 wherein search is based on the names of the controlling device and the controlled device.

23. The system of claim 19 wherein the controlling device and the controlled device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

24. A network of devices comprising:
a. a server for storing a script and distributing the script over a network;
b. a controlled device for being controlled remotely; and
c. a controlling device for searching for and acquiring the script to control the controlled device.

25. A controlling device comprising:
a. a memory for storing an application, the application for:
i. discovering a controlled device;
ii. sending device information about the controlling device and the controlled device to a server to locate a script;
iii. acquiring the script from the server; and
iv. controlling the controlled device utilizing the script; and
b. a processing component coupled to the memory, the processing component configured for processing the application.
